(19) United States
(12) Patent Application Publication
(10) Pub. No.: US 2026/0367611 A1
(43) Pub. Date: Nov. 19, 2026

(54) INFORMATION PROCESSING METHOD, INFORMATION PROCESSING DEVICE, AND PROGRAM

(71) Applicant: Panasonic Intellectual Property Management Co., Ltd., Osaka (JP)

(72) Inventors: Taichi SATO, Kyoto (JP); Shun TAKAYANAGI, Osaka (JP); Naganori SHIRAKATA, Osaka (JP)

(21) Appl. No.: 19/158,727

(22) PCT Filed: Jan. 23, 2024
(86) PCT No.: PCT/JP2024/001841

§ 371 Date: Aug. 21, 2025

(30) Foreign Application Priority Data
Mar. 20, 2023 (JP) 2023-044083

(51) Int. Cl. G05B 19/418

(52) U.S. Cl. CPC G05B 19/41865

(57) ABSTRACT

An information processing device selects at least one representative operation from operations that can be executed by a device, causes the device to execute the representative operation, acquires measurement data of a predetermined evaluation index measured in the execution of the representative operation, and updates a control parameter based on acquired measurement data. In at least one of a first period in which a first representative operation is executed, a second period in which a second representative operation is executed, and a third period between the first period and the second period, the device is caused to execute a predetermined evaluation operation for comprehensively evaluating the operation of the device, measurement data of the evaluation index measured in the execution of the evaluation operation is acquired, the comprehensive evaluation is performed based on the acquired measurement data, and result data indicating an evaluation result of the comprehensive evaluation is output.

### TECHNICAL FIELD

The present disclosure relates to an information processing method, an information processing device, and a program.

### BACKGROUND ART

A control parameter generation method according to the background art is disclosed in, for example, Patent Literature 1.

Conventionally, generation of an appropriate control parameter has been desired.

### CITATION LIST

### Patent Literature

Patent Literature 1: WO 2018/151215 A

### SUMMARY OF INVENTION

An object of the present disclosure is to provide an information processing method, an information processing device, and a program capable of efficiently generating appropriate control parameters.

An information processing method according to one aspect of the present disclosure is an information processing method for optimizing control parameters in a device that executes a plurality of operations based on a plurality of the control parameters, the information processing method performed by an information processing device, including: in control parameter optimization processing, selecting at least one representative operation from all operations that can be executed by the device, executing the selected representative operation by the device, acquiring measurement data of a predetermined evaluation index measured in the executing of the representative operation, and updating the control parameter based on the acquired measurement data, the representative operation including a first representative operation and a second representative operation executed after the first representative operation; and in evaluation result output processing, executing, by the device, a predetermined evaluation operation for comprehensively evaluating an operation of the device in at least one of a first period in which the first representative operation is executed, a second period in which the second representative operation is executed, and a third period between the first period and the second period, acquiring measurement data of the evaluation index measured in execution of the evaluation operation, performing the comprehensive evaluation based on the acquired measurement data, and outputting result data indicating an evaluation result of the comprehensive evaluation.

### BRIEF DESCRIPTION OF DRAWINGS

FIG. 1 is a diagram illustrating a configuration of a control parameter generation device according to an embodiment of the present disclosure in a simplified manner.

FIG. 2 is a diagram illustrating an example of the control parameter in a simplified manner.

FIG. 3 is a diagram illustrating an example of a selection rule in a simplified manner.

FIG. 4 is a schematic diagram illustrating an example of transition of a positional deviation of a driven object with respect to a target position.

FIG. 5 is a diagram illustrating an example of measurement data output by a sensor in a simplified manner.

FIG. 6 is a flowchart illustrating processing executed by an information processing unit.

FIG. 7 is a flowchart illustrating details of control parameter optimization processing.

FIG. 8 is a flowchart illustrating details of evaluation result output processing.

FIG. 9 is a diagram illustrating an example of an image including evaluation results regarding a representative operation and an evaluation operation in a simplified manner.

FIG. 10 is a diagram illustrating a modification of an image including evaluation results regarding a representative operation and an evaluation operation in a simplified manner.

FIG. 11 is an enlarged view illustrating a part of the image illustrated in FIG. 9.

FIG. 12 is an enlarged view illustrating a part of another example of the image including the evaluation result.

### DESCRIPTION OF EMBODIMENTS

### Knowledge Underlying Present Disclosure

As a method for generating appropriate control parameters of a drive unit in a production device including the drive unit such as a servomotor that drives a driven object, in recent years, a method for generating appropriate control parameters by searching for appropriate control parameters using a machine learning model or the like has been proposed (see, for example, Patent Literature 1).

In general, the number of control parameters of the drive unit used in the production device may be 50 or more. Further, a number of adjustment gradations may be 100 or more.

For example, in a case where the production device performs 80 operations, the number of control parameters of the drive source is 50, and the number of adjustment gradations of the control parameters is 100, the number of combinations thereof is 100⁵⁰×80.

The inventors have found a problem that in a case where control parameters are generated for such an enormous number of combinations, at a time of using a method for searching for appropriate control parameters using a machine learning model or the like, enormous time is required to search for appropriate control parameter or no matter how much time it takes, no appropriate control parameter cannot be acquired due to an excessively wide search range.

Therefore, the inventors have intensively repeated experiments and studies in order to achieve a parameter generation method capable of efficiently generating appropriate control parameters even in a case where control parameters are generated for an enormous number of combinations.

Through the above experiments and studies, the inventors have obtained findings such that, in a case where, for example, 80 operations are performed by the production device, appropriate control parameters can be generated more efficiently and reliably for combinations of all the 80 operations by repeating steps described below and finally searching for appropriate control parameters for all the 80 operations without searching for appropriate control parameters for all huge combinations from the beginning. The steps include a first step of searching for appropriate control parameters for some of the 80 operations, for example, only one operation, that is, only some combinations among the huge combinations, a next step of increasing the number of operations performed by the production device and searching for appropriate control parameters for a combination of two operations using a search result in the first step, and a still next step of further increasing the number of operations performed by the production device and searching for appropriate control parameters, for example, for a combination of four operations using a search result in the previous step.

The inventors further conducted experiments and studies based on the above findings, and conceived a control parameter generation method and the like according to the present disclosure described below.

Next, each aspect of the present disclosure will be described.

An information processing method according to a first aspect of the present disclosure is an information processing method for optimizing control parameters in a device that executes a plurality of operations based on a plurality of the control parameters, the information processing method performed by an information processing device, including: in control parameter optimization processing, selecting at least one representative operation from all operations that can be executed by the device, executing the selected representative operation by the device, acquiring measurement data of a predetermined evaluation index measured in the executing of the representative operation, and updating the control parameter based on the acquired measurement data, the representative operation including a first representative operation and a second representative operation executed after the first representative operation; and in evaluation result output processing, executing, by the device, a predetermined evaluation operation for comprehensively evaluating an operation of the device in at least one of a first period in which the first representative operation is executed, a second period in which the second representative operation is executed, and a third period between the first period and the second period, acquiring measurement data of the evaluation index measured in execution of the evaluation operation, performing the comprehensive evaluation based on the acquired measurement data, and outputting result data indicating an evaluation result of the comprehensive evaluation.

According to the first aspect, the control parameter is updated by causing the device to execute the representative operation among all the operations, and for example, the number of operations included in the representative operation is gradually increased to repeat the optimization processing, whereby an appropriate control parameter can be efficiently generated. Further, in at least one of the first period in which the first representative operation is executed, the second period in which the second representative operation is executed, and the third period between the first period and the second period, the comprehensive evaluation is performed by causing the device to execute the predetermined evaluation operation, and the result data indicating the evaluation result is output. Therefore, it is possible to present the progress of the optimization of the control parameter in all the operations of the device to the user in the middle stage of the optimization processing.

In accordance with a second aspect of the present disclosure, in the information processing method according to the first aspect, the evaluation operation may be all the operations.

According to the second aspect, accurate comprehensive evaluation can be made by causing the device to perform all the operations as the evaluation operation.

In the information processing method according to a third aspect of the present disclosure, in the second aspect, in the control parameter optimization processing, a next representative operation may be selected based on execution results of all the operations executed as the evaluation operation.

According to the third aspect, the next representative operation can be appropriately selected based on the execution results of all the latest operations.

In the information processing method according to a fourth aspect of the present disclosure, in the third aspect, in the control parameter optimization processing, all the operations executed as the evaluation operation may be clustered into a plurality of clusters, and the next representative operation may be selected from each cluster.

According to the fourth aspect, the next representative operation can be appropriately selected.

In the information processing method according to a fifth aspect of the present disclosure, in the first aspect, the evaluation operation may be a differential operation between all the operations and a most recent representative operation with respect to the evaluation operation.

According to the fifth aspect, by causing, as the evaluation operation, the device to perform the differential operation between all the operations and the most recent representative operation with respect to the evaluation operation, the efficiency of the evaluation operation can be improved while the accuracy of the comprehensive evaluation is being maintained.

In the information processing method according to a sixth aspect of the present disclosure, in the first aspect, the evaluation operation may be a prescribed operation defined in advance from all the operations.

According to the sixth aspect, as the evaluation operation, the efficiency of the evaluation operation can be improved by causing the device to perform the prescribed operation defined in advance from all the operations.

In the information processing method according to a seventh aspect of the present disclosure, in the first aspect, in the outputting of the result data, an image indicating the evaluation result may be generated as the result data, and the generated image may be displayed on a display unit.

According to the seventh aspect, by displaying the image indicating the evaluation result on the display unit, the progress of the optimization of the control parameter can be presented to the user in an easy-to-understand manner.

The information processing method according to an eighth aspect of the present disclosure, in the seventh aspect, may further include: calculating an evaluation value of the evaluation index related to the representative operation based on the measurement data acquired along with execution of the representative operation; and calculating an evaluation value of the evaluation index related to the evaluation operation based on the measurement data acquired along with execution of the evaluation operation, in which the image includes: time-series data of the evaluation value related to the representative operation; and time-series data of the evaluation value related to the evaluation operation.

According to the eighth aspect, the image indicating the evaluation result includes the time-series data of the evaluation value related to the representative operation and the time-series data of the evaluation value related to the evaluation operation, so that the progress of the optimization of the control parameter can be presented to the user in an easy-to-understand manner.

The information processing method according to a ninth aspect of the present disclosure, in the eighth aspect, may further include extracting an evaluation value corresponding to the representative operation from evaluation values of the evaluation indexes related to the evaluation operation to add the time-series data of the evaluation value related to the representative operation.

According to the ninth aspect, by extracting the evaluation value corresponding to the representative operation from the evaluation value of the evaluation index related to the evaluation operation, it is possible to add the time-series data of the evaluation value related to the representative operation and to extend or retroactively present the characteristic to the user.

The information processing method according to a tenth aspect of the present disclosure, in the eighth aspect, may further include: receiving, by a user, an input operation of a request for selecting one evaluation value from the time-series data of the evaluation value related to the representative operation; and setting the control parameter when the evaluation operation is executed next time, based on the control parameter when the representative operation corresponding to the one evaluation value is executed.

According to the tenth aspect, since the user can easily set the control parameter when the evaluation operation is executed next time by the input operation while viewing the screen displayed on the display unit, the convenience of the user can be improved.

The information processing method according to an eleventh aspect of the present disclosure, in the first aspect, may further include: determining whether the evaluation result of the comprehensive evaluation satisfies a predetermined end condition; and ending the optimization processing of the control parameter in a case where the evaluation result satisfies the end condition.

According to the eleventh aspect, in a case where the evaluation result of the comprehensive evaluation satisfies a predetermined end condition, the optimization processing ends even before the representative operations arrive at the final stage, and thus the time required for the optimization processing can be shortened.

The information processing method according to a twelfth aspect of the present disclosure, in the first aspect, may further include: receiving an input operation of a request for executing of the evaluation operation by a user; and executing, by the device, the evaluation operation based on the execution request.

According to the twelfth aspect, since the user can cause the device to execute the evaluation operation by the input operation of the execution request of the evaluation operation, the convenience of the user can be improved.

The information processing method according to a thirteenth aspect of the present disclosure, in the first aspect, may further include: calculating an evaluation value of the evaluation index related to the representative operation based on the measurement data acquired along with execution of the representative operation; calculating a variance of a plurality of the evaluation values related to a plurality of the representative operations; and setting a number of executions of the evaluation operation to be executed next time based on the variance.

According to the thirteenth aspect, since the number of executions of the evaluation operation to be executed next time can be appropriately set based on the variance of the plurality of evaluation values regarding the plurality of representative operations, the evaluation accuracy of the comprehensive evaluation can be improved.

The information processing method according to a fourteenth aspect of the present disclosure, in the first aspect, may further include: calculating an evaluation value of the evaluation index related to the representative operation based on the measurement data acquired along with execution of the representative operation; and setting the control parameter when the evaluation operation is executed next time, based on a plurality of the evaluation values related to a plurality of the representative operations.

According to the fourteenth aspect, it is possible to appropriately set the control parameter when the evaluation operation is executed next time based on the plurality of evaluation values related to the plurality of representative operations.

In the information processing method according to a fifteenth aspect of the present disclosure, in the fourteenth aspect, in the setting of the control parameter, the control parameter when the representative operation corresponding to a best evaluation value among a plurality of the evaluation values is executed may be set as the control parameter when the evaluation operation is executed next time.

According to the fifteenth aspect, the control parameter at the time of executing the next evaluation operation can be appropriately set based on the control parameter at the time of executing the representative operation corresponding to the best evaluation value among the plurality of evaluation values, so that the evaluation accuracy of the comprehensive evaluation can be improved.

The information processing method according to a sixteenth aspect of the present disclosure is an information processing method for optimizing control parameters in a device that executes a plurality of operations based on a plurality of the control parameters, the information processing method performed by an information processing device, includes: selecting at least one representative operation from all operations that can be executed by the device, executing the selected representative operation by the device, acquiring measurement data of a predetermined evaluation index measured in the executing of the representative operation, and updating the control parameter based on the acquired measurement data; executing, by the device, a predetermined evaluation operation for comprehensively evaluating an operation of the device within a period in which the representative operation is executed, acquiring measurement data of the evaluation index measured in execution of the evaluation operation, and performing the comprehensive evaluation based on the acquired measurement data; and selecting a next representative operation based on an execution result of the evaluation operation.

According to the sixteenth aspect, the next representative operation can be appropriately selected based on the execution result of the latest evaluation operation.

The information processing device according to a seventeenth aspect of the present disclosure is an information processing device for optimizing control parameters in a device that executes a plurality of operations based on a plurality of the control parameters, the information processing device includes: a selection unit; a control unit; an acquisition unit; an update unit; and an output unit, in which in control parameter optimization processing, the selection unit selects at least one representative operation from all operations that can be executed by the device, the control unit causes the device to execute the representative operation selected by the selection unit, the acquisition unit acquires measurement data of a predetermined evaluation index measured in the executing of the representative operation, and the update unit updates the control parameter based on the measurement data acquired by the acquisition unit, the representative operation includes a first representative operation and a second representative operation executed after the first representative operation, and in evaluation result output processing, the control unit causes the device to execute a predetermined evaluation operation for comprehensively evaluating an operation of the device in at least one of a first period in which the first representative operation is executed, a second period in which the second representative operation is executed, and a third period between the first period and the second period, the acquisition unit acquires measurement data of the evaluation index measured in execution of the evaluation operation, and the output unit performs the comprehensive evaluation based on the measurement data acquired by the acquisition unit and outputs result data indicating an evaluation result of the comprehensive evaluation.

According to the seventeenth aspect, the control parameter is updated by causing the device to execute the representative operation among all the operations, and for example, the number of operations included in the representative operation is gradually increased to repeat the optimization processing, whereby an appropriate control parameter can be efficiently generated. Further, in at least one of the first period in which the first representative operation is executed, the second period in which the second representative operation is executed, and the third period between the first period and the second period, the comprehensive evaluation is performed by causing the device to execute the predetermined evaluation operation, and the result data indicating the evaluation result is output. Therefore, it is possible to present the progress of the optimization of the control parameter in all the operations of the device to the user in the middle stage of the optimization processing.

A program according to an eighteenth aspect of the present disclosure is a program for causing an information processing device for optimizing control parameters in a device that executes a plurality of operations based on a plurality of the control parameters to execute selection processing, control processing, acquisition processing, update processing, and output processing, in which in control parameter optimization processing, the selection processing selects at least one representative operation from all operations that can be executed by the device, the control processing causes the device to execute the representative operation selected by the selection processing, the acquisition processing acquires measurement data of a predetermined evaluation index measured in the executing of the representative operation, and the update processing updates the control parameter based on the measurement data acquired by the acquisition processing, the representative operation includes a first representative operation and a second representative operation executed after the first representative operation, and in evaluation result output processing, the control processing causes the device to execute a predetermined evaluation operation for comprehensively evaluating an operation of the device in at least one of a first period in which the first representative operation is executed, a second period in which the second representative operation is executed, and a third period between the first period and the second period, the acquisition processing acquires measurement data of the evaluation index measured in execution of the evaluation operation, and the output processing performs the comprehensive evaluation based on the measurement data acquired by the acquisition processing and outputs result data indicating an evaluation result of the comprehensive evaluation.

According to the eighteenth aspect, the control parameter is updated by causing the device to execute the representative operation among all the operations, and for example, the number of operations included in the representative operation is gradually increased to repeat the optimization processing, whereby an appropriate control parameter can be efficiently generated. Further, in at least one of the first period in which the first representative operation is executed, the second period in which the second representative operation is executed, and the third period between the first period and the second period, the comprehensive evaluation is performed by causing the device to execute the predetermined evaluation operation, and the result data indicating the evaluation result is output. Therefore, it is possible to present the progress of the optimization of the control parameter in all the operations of the device to the user in the middle stage of the optimization processing.

The present disclosure can also implement each characteristic configuration included in such a method or device as a program to be executed by a computer or as a system operated by this program. It is needless to say that such a computer program can be distributed via a computer-readable non-transitory recording medium such as a CD-ROM or via a communication network such as the Internet.

### Embodiments of Present Disclosure

Embodiments of the present disclosure will be described below in detail with reference to the drawings. Elements denoted with the same reference symbol in different drawings represent the same or corresponding elements. Constituent elements, placement positions of the constituent elements, connection forms, the order of operations, and the like shown in the following embodiments are an example, and are not intended to limit the present disclosure. The present disclosure is limited only by the claims. Therefore, a constituent element that is not described in an independent claim indicating the most generic concept of the present disclosure among constituent elements in the following embodiments is not necessarily required to achieve the object of the present disclosure, but the constituent element is described as constituting a more preferable form.

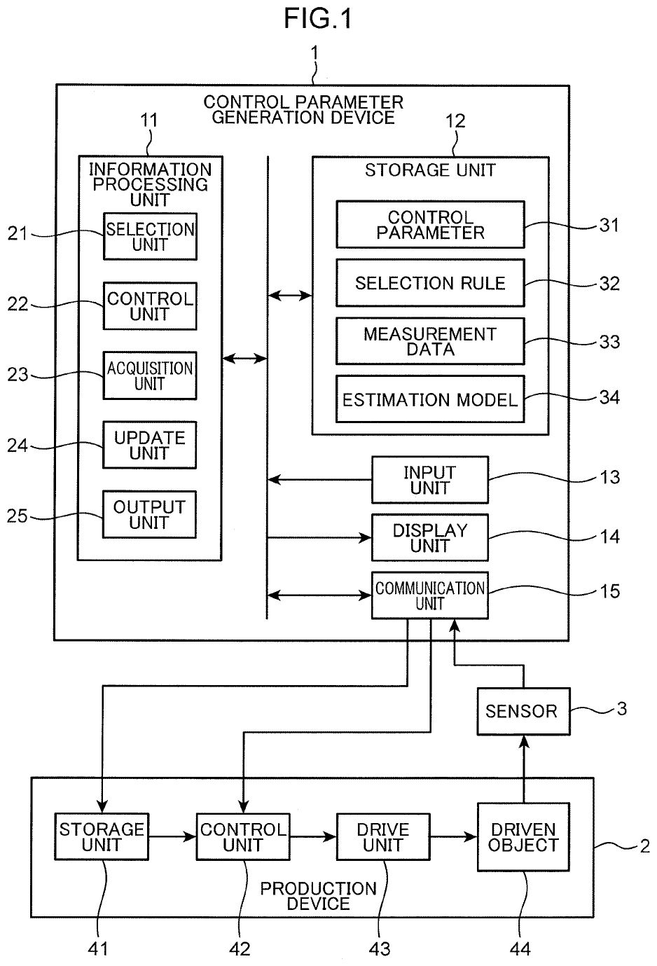

FIG. 1 is a diagram illustrating a configuration of a control parameter generation system according to an embodiment of the present disclosure in a simplified manner. The control parameter generation system is a system that optimizes a control parameter 31 by generating and updating the control parameter 31 used for a target production device 2. The control parameter generation system includes a control parameter generation device 1 and a sensor 3.

The production device 2 is a device used for producing a machine, and is a mounting device, a processing device, a machining device, a conveyance device, or the like for mounting, processing, machining, conveying, or the like of a machine. The production device 2 is installed, for example, in a production line of a factory.

The production device 2 can execute N (N is an integer of 3 or more) operations. N is, for example, 80. Note that the present disclosure is applicable not only to the production device 2 but also to any device capable of executing N operations.

The production device 2 includes a storage unit 41, a control unit 42, a drive unit 43, and a driven object 44.

The storage unit 41 is configured using an HDD, an SSD, a semiconductor memory, or the like.

The control unit 42 is configured using a processor such as a CPU.

The control unit 42 controls an operation of the drive unit 43, and drives the driven object 44.

The drive unit 43 is, for example, a servomotor, a fluid directional flow control valve used for controlling a pneumatic artificial muscle arm, or a fluid directional flow control valve used for controlling a hydraulic arm. The servomotor may be, for example, a rotary motor or a linear motor.

The driven object 44 is an object to be driven by the drive unit 43. For example, in a case where the drive unit 43 is a servomotor, the driven object 44 is a head that carries a part to be machined, a nozzle provided at the head to suck the part to be machined, or the like. In addition, the driven object 44 is a pneumatic artificial muscle arm, a hydraulic arm, or the like in a case where the drive unit 43 is a directional flow control valve.

The control unit 42 controls the drive unit 43 by outputting a command to the drive unit 43 to move the driven object 44 to a predetermined target position. The command output from the control unit 42 to the drive unit 43 may be, for example, a position command for commanding the position of the drive unit 43 or the driven object 44, or may be, for example, a torque command for commanding a torque of the drive unit 43.

The storage unit 41 stores the control parameter 31 generated and updated by the control parameter generation device 1. The control unit 42 controls the drive unit 43 based on the control parameter 31 read from the storage unit 41. In other words, the control unit 42 uses the control parameter 31 when controlling the drive unit 43. The number of control parameters 31 is, for example, 50.

The control parameter generation device 1 includes an information processing unit 11, a storage unit 12, an input unit 13, a display unit 14, and a communication unit 15.

The information processing unit 11 is configured using a processor such as a CPU. As functions implemented by the processor executing a program read from a nonvolatile recording medium such as a computer-readable ROM, the information processing unit 11 includes a selection unit 21, a control unit 22, an acquisition unit 23, an update unit 24, and an output unit 25. In other words, the program is a program for causing the information processing unit 11 as an information processing device mounted in the control parameter generation device 1 to function as the selection unit 21 (selection means), the control unit 22 (control means), the acquisition unit 23 (acquisition means), the update unit 24 (update means), and the output unit 25 (output means). Details of the processing content executed by each processing unit will be described later.

The storage unit 12 is configured using an HDD, an SSD, a semiconductor memory, or the like. The storage unit 12 stores the control parameter 31, a selection rule 32, measurement data 33, and an estimation model 34.

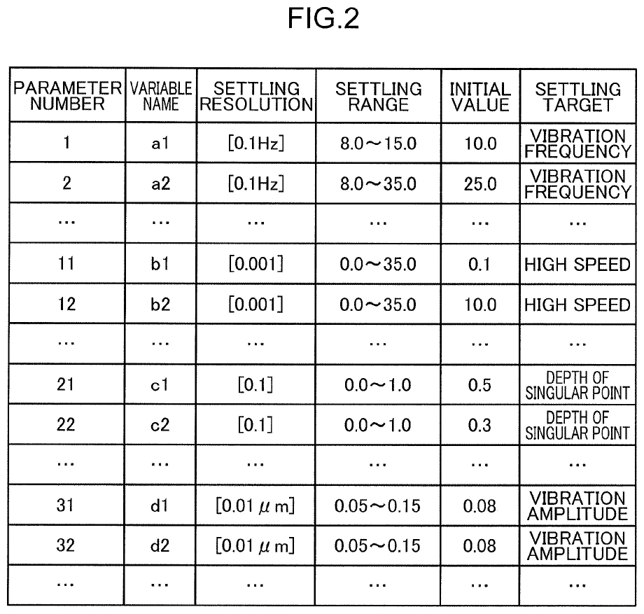

FIG. 2 is a diagram illustrating an example of the control parameter 31 in a simplified manner. The control parameters 31 includes parameters a1 and a2 for adjusting a vibration frequency of the driven object 44, parameters b1 and b2 for adjusting an increase in the speed of the driven object 44, parameters c1 and c2 for adjusting the depth of a singular point in the vibration characteristic of the driven object 44, parameters d1 and d2 for adjusting the vibration amplitude of the driven object 44, and the like. The control parameters 31 may include, for example, parameters having a trade-off relationship with each other, such as the parameters b1 and b2, the parameters c1 and c2, and the parameters d1 and d2.

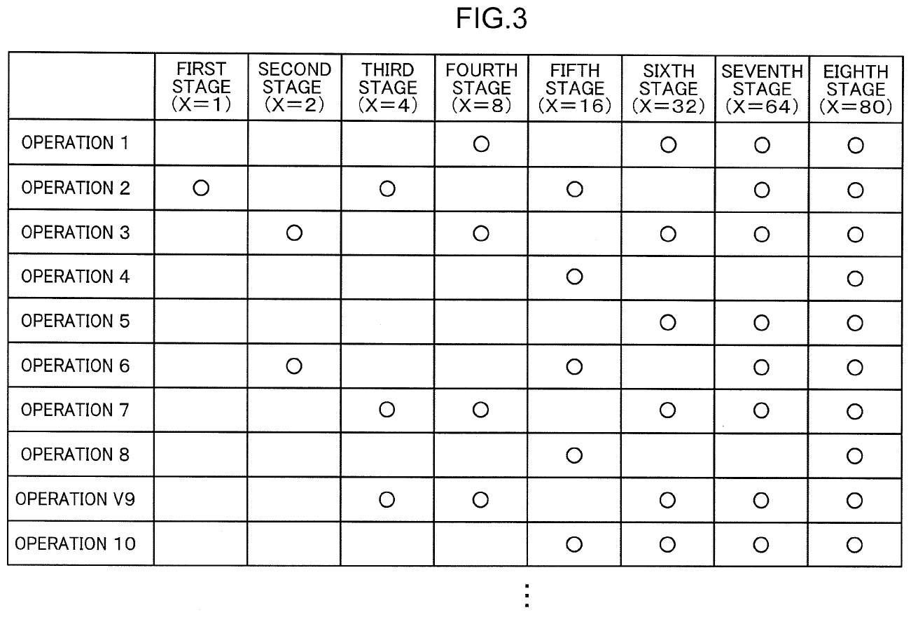

FIG. 3 is a diagram illustrating an example of the selection rule 32 in a simplified manner. The selection rule 32 indicates a rule when the selection unit 21 selects at least one representative operation from all the N operations that can be executed by the production device 2. The representative operation is an operation that the control parameter generation device 1 causes the production device 2 to execute in the control parameter optimization processing. In the example illustrated in FIG. 3, the representative operations are executed in the eight stages from the first to eighth stages, and the number X of operations included in the representative operations increases as the stage advances. For example, the number X of operations in the first stage is one, and the representative operation includes only operation 2. In addition, the number X of operations in the second stage is two, and the representative operations include operations 3 and 6. In addition, the number X of operations in the third stage is four, and the representative operations include operations 2, 7, 9 . . . In addition, the number X of operations in the fourth stage is eight, and the representative operations include operations 1, 3, 7, 9 . . . In addition, the number X of operations in the fifth stage is 16, and the representative operations include operations 2, 4, 6, 8, 10 . . . In addition, the number X of operations in the sixth stage is 32, and the representative operations include operations 1, 3, 5, 7, 9, 10 . . . In addition, the number X of operations in the seventh stage is 64, and the representative operations include operations 1, 2, 3, 5, 6, 7, 9, 10 . . . In addition, the representative operations in the eighth stage include all the operations 1 to 50.

The selection rule 32 is designated in advance by the user by an operation input using the input unit 13. Note that the selection rule 32 is not limited to designation by the user, and the number of representative operations and the operations in each stage may be set in advance according to a predetermined rule, or the number of representative operations and the operations in each stage may be dynamically changed by a specifying method designated by the user.

In addition, the selection rule 32 may include setting information of an operation to be executed in the evaluation operation among all the N operations that can be executed by the production device 2. The evaluation operation is an operation that the control parameter generation device 1 causes the production device 2 to execute in the evaluation result output processing in order to comprehensively evaluate the operation of the production device 2. In the example of the present embodiment, the evaluation operation includes all operations. The evaluation operation is performed in at least one of a period of time during which the representative operations in each stage are performed and in a transition period of time from a certain stage to the next stage. In the example illustrated in FIG. 3, the representative operations of the eighth stage including all the operations may be executed as the evaluation operation including all the operations.

In addition, the selection is not limited to the selection using the selection rule 32, and the next representative operation may be selected based on the execution results of all the latest operations (step SP062) executed as the evaluation operation. For example, a plurality of operations may be specified in descending order of the evaluation value from all the operations, and the plurality of operations may be selected as the next representative operation.

Alternatively, all the operations executed as the evaluation operation may be clustered into a plurality of clusters, and an operation having the worst evaluation value in each cluster or an operation randomly selected from each cluster may be selected as the next representative operation. As a result, the next representative operation can be appropriately selected based on the execution results of all the latest operations reflecting the latest situation.

The evaluation operation is not limited to all the operations, and may be a differential operation between all the operation and the most recent representative operation with respect to the evaluation operation. For example, regarding a period in which the representative operations of the fourth stage are executed, since the representative operations include operations 1, 3, 7, 9 . . . , the evaluation operations executed within the period include operations 2, 4, 5, 6, 8, 10 . . . which are differences between all the operations and the representative operations.

Furthermore, for example, regarding the period in which the representative operations of the fifth stage are executed, since the representative operations include operations 2, 4, 6, 8, 10 . . . , the evaluation operations executed within the transition period from the fifth stage to the sixth stage include operations 1, 3, 5, 7, 9 . . . , which are differences between all the operations and the representative operations.

Furthermore, the evaluation operation is not limited to all the operations, and may be a prescribed operation prescribed from all the operations. For example, a plurality of predetermined operations is determined as the prescribed operations in descending order of an influence on the operation performance of the production device 2 among all the operations. In the evaluation operation, the control parameter generation device 1 causes the production device 2 to execute only the specified operation.

Referring to FIG. 1, the measurement data 33 is data indicating a measurement value of a predetermined evaluation index measured by the sensor 3 in the execution of the representative operation and the evaluation operation. A plurality of pieces of measurement data 33 are accumulated in the storage unit 12 to form a database. The evaluation index may be any index as long as it can quantitatively evaluate the operation of the production device 2, and the settling time is used in the example of the present embodiment.

The sensor 3 measures the position of the driven object 44 in the representative operation and the evaluation operation along a time series. The measurement data 33 indicating the measurement position corresponding to each operation included in the representative operations and the evaluation operations is transmitted to the control parameter generation device 1.

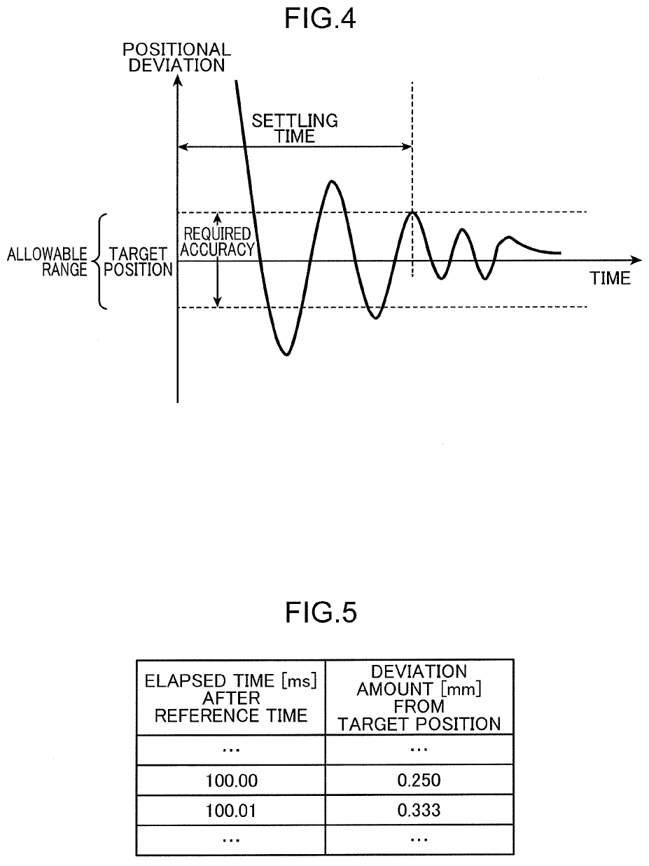

FIG. 4 is a schematic diagram illustrating an example of transition of a positional deviation of the driven object 44 with respect to a target position when the production device 2 moves the driven object 44 to the target position.

In FIG. 4, the horizontal axis represents time, and the vertical axis represents the positional deviation of the driven object 44 with respect to the target position.

As illustrated in FIG. 4, in this specification, the allowable range means a range in which the positional deviation from the target position is within required accuracy.

Further, as illustrated in FIG. 4, in this specification, the time (hereinafter, also referred to as “settling time”) of arrival at the allowable position that can be evaluated as having arrived at the target position means the time at which the driven object 44 finally arrives within the allowable range in a case where the driven object has not deviated from the allowable range again after arriving at the allowable range.

As illustrated in FIG. 4, in the present specification, the settling time refers to a time from the start of stopping of the driven object 44 based on a command to move the driven object 44 to the target position until the driven object 44 reaches an allowable position where it can be evaluated that the driving object reaches the target position, that is, a time from the stop start time to the settling time. Alternatively, the settling time refers to a time from the start of moving of the driven object 44 based on a command to move the driven object 44 to the target position until the driven object 44 reaches an allowable position where it can be evaluated that the driving object reaches the target position, that is, a time from the move start time to the settling time.

FIG. 5 is a diagram illustrating an example of the measurement data 33 output from the sensor 3 in a simplified manner.

As illustrated in FIG. 5, the measurement data 33 is data in which an elapsed time [ms] after a reference time and a deviation amount [mm] from the target position are associated on a one-to-one basis. Here, the reference time is a stop start time of the driven object 44 based on the command for setting the driven object 44 to the target position, or a move start time of the driven object 44 based on the command for moving the driven object 44 to the target position.

Referring to FIG. 1, the estimation model 34 is a learned model by machine learning for optimizing the control parameter 31. The estimation model 34 may include a machine learning program. Alternatively, the control parameter 31 may be optimized using a machine learning program instead of the estimation model 34. The update unit 24 executes optimization for shortening the longest settling time among the settling times corresponding to the respective operations included in the representative operations using the estimation model 34. As a result, the control parameter 31 is updated. The object to be optimized is not limited to the longest settling time, and may be an average value of a plurality of settling times, or may be a predetermined plurality of settling times or an average value thereof in descending order.

As an algorithm for optimization, a known algorithm such as a Bayesian optimization algorithm, an evolutionary strategy algorithm (CMA-ES), a genetic algorithm (GA), or deep reinforcement learning can be used.

The information processing unit 11 and/or the storage unit 12 may be implemented in an external terminal or a server device capable of communicating with the control parameter generation device 1. The external terminal includes a personal computer, a smartphone, a tablet terminal, or the like. The server device includes an edge server, a cloud server, or the like.

The input unit 13 is configured using an arbitrary input device such as a mouse, a keyboard, or a touch panel.

The display unit 14 is configured using arbitrary device such as a liquid crystal display or an organic EL display.

The communication unit 15 is configured using a communication module compatible with an arbitrary communication method such as Bluetooth (registered trademark) or Wi-Fi.

The communication unit 15 transmits the control parameter 31 stored in the storage unit 12 to the production device 2. When the production device 2 receives the control parameter 31 from the control parameter generation device 1, the storage unit 41 overwrites the stored control parameter 31 with the received new control parameter 31. That is, the control parameter 31 is updated.

In addition, the communication unit 15 transmits a control signal for executing the representative operation or the evaluation operation to the production device 2. When the production device 2 receives the control signal from the control parameter generation device 1, the control unit 42 executes the representative operation or the evaluation operation by controlling the drive unit 43 based on the control signal and the control parameter 31 read from the storage unit 41.

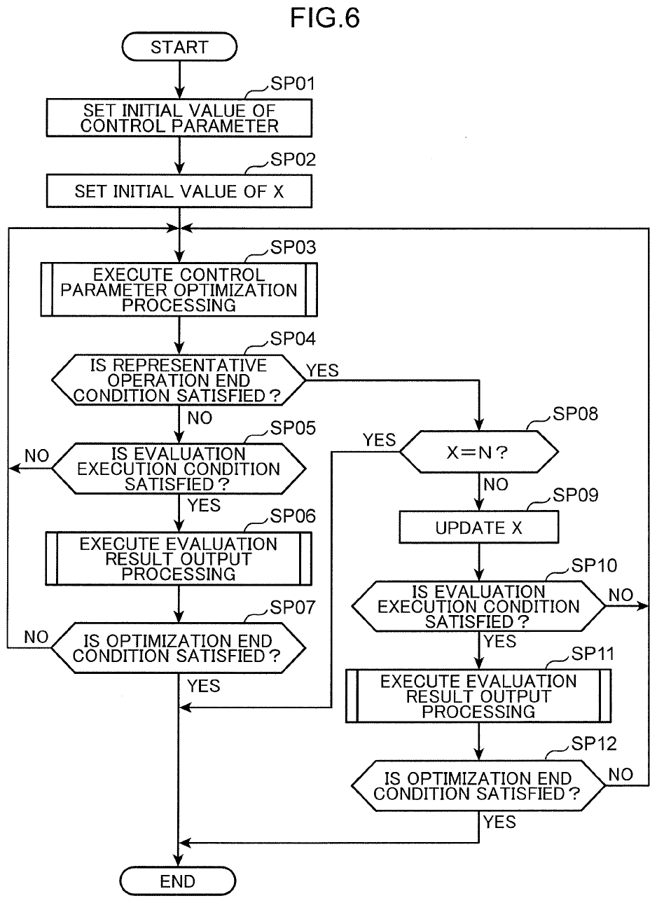

FIG. 6 is a flowchart illustrating processing executed by the information processing unit 11.

First, in step SP01, the update unit 24 sets an initial value of the control parameter 31. The initial value may be a predetermined value, a value designated by the user through an operation input using the input unit 13, or a value calculated by the update unit 24 using a calculation method designated by the user through an operation input using the input unit 13. The initial value of the control parameter 31 set by the update unit 24 is stored in the storage unit 12 and transmitted to the production device 2 by the communication unit 15. The production device 2 stores the received initial value of the control parameter 31 in the storage unit 41.

Next, in step SP02, the selection unit 21 sets an initial value of an integer-type variable indicating the number X of operations of the representative operations. The selection unit 21 refers to the selection rule 32 to set an initial value 1 of the integer-type variable as the number X of operations in the first stage. In the present embodiment, an example in which the initial value of the integer-type variable is 1 will be described, but the initial value may be an integer of 1 or more and N-1 or less and is not necessarily limited to 1. In addition, the initial value of the integer-type variable may be designated by the user by an operation input using the input unit 13.

Next, in step SP03, the information processing unit 11 executes control parameter optimization processing.

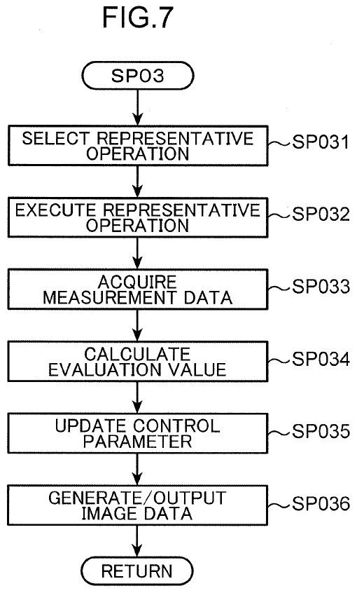

FIG. 7 is a flowchart illustrating details of the control parameter optimization processing.

First, in step SP031, the selection unit 21 selects X representative operations from all the N operations by referring to the selection rule 32. Specifically, the selection unit 21 selects one operation 2 as the representative operation of the first stage. Note that, as described above, the selection is not limited to the selection using the selection rule 32, and the next representative operation may be selected based on the execution results of all the latest operations (step SP062) executed as the evaluation operation. For example, a plurality of operations may be specified in descending order of the evaluation value from all the operations, and the plurality of operations may be selected as the next representative operation. Alternatively, all the operations executed as the evaluation operation may be clustered into a plurality of clusters, and an operation having the worst evaluation value in each cluster or an operation randomly selected from each cluster may be selected as the next representative operation.

Next, in step SP032, the control unit 22 generates a control signal for causing the production device 2 to execute the representative operation selected by the selection unit 21. The control signal generated by the control unit 22 is transmitted to the production device 2 by the communication unit 15. When the production device 2 receives the control signal, the control unit 42 executes the representative operations including the X operations by controlling the drive unit 43 based on the control signal and the control parameter 31 read from the storage unit 41. When the production device 2 executes X operations, the sensor 3 transmits X pieces of measurement data 33 corresponding to each of the X operations included in the representative operations to the control parameter generation device 1. The communication unit 15 receives the X pieces of measurement data 33 transmitted from the sensor 3, stores the X pieces of measurement data in the storage unit 12, and inputs the X pieces of measurement data to the information processing unit 11.

Next, in step SP033, the acquisition unit 23 acquires X pieces of measurement data 33 corresponding to each of the X operations included in the representative operations from the communication unit 15.

Next, in step SP034, the update unit 24 calculates an evaluation value of the evaluation index for each of the X pieces of measurement data 33 acquired by the acquisition unit 23. In the example of the present embodiment, the update unit 24 calculates the settling time for each of the X pieces of measurement data 33.

Next, in step SP035, the update unit 24 updates the control parameter 31 by executing optimization for shortening the longest settling time among the X settling times regarding the calculated X pieces of measurement data 33 using the estimation model 34. The control parameter 31 updated by the update unit 24 is stored in the storage unit 12 and transmitted to the production device 2 by the communication unit 15. The production device 2 stores the received updated control parameter 31 in the storage unit 41.

Next, in step SP036, the output unit 25 generates image data including the evaluation result regarding the current representative operation based on the X settling times regarding the X pieces of measurement data 33 calculated in step SP034, and outputs the generated image data. For example, the output unit 25 adopts the longest settling time among the X settling times as an evaluation value related to the current representative operation, and generates image data including an evaluation result indicating the evaluation value. The image data output from the output unit 25 is input to the display unit 14, and the display unit 14 displays an image based on the input image data.

In FIG. 7, an example in which the selection of the representative operation (step SP031) is executed every time before the execution of the representative operation (step SP032) is illustrated, but the present invention is not limited thereto. The representative operation may be selected every predetermined number of times (for example, several tens to several hundreds of times) of execution of the representative operation or every predetermined time interval. As a result, the operation can be speeded up as compared with the case where the selection of the representative operation is executed every time.

Referring to FIG. 6, after step SP03, in step SP04, the control unit 22 determines whether a predetermined representative operation end condition is satisfied. As the representative operation end condition, a target value of the evaluation value in each stage may be set, the upper limit number of times of repetition of the optimization processing in each stage may be set, or the upper limit time of the execution time of the optimization processing in each stage may be set. For example, in a case where the target value of the evaluation value is set as the representative operation end condition, the control unit 22 determines that the representative operation end condition is not satisfied in a case where the evaluation value of the latest representative operation (the longest one among the X settling times) exceeds the target value, and determines that the representative operation end condition is satisfied in a case where the evaluation value of the latest representative operation is equal to or less than the target value.

In a case where the representative operation end condition is not satisfied (step SP04: NO), next, in step SP05, the control unit 22 determines whether the predetermined evaluation execution condition is satisfied. The evaluation execution condition includes that a certain time has elapsed from the reference time. The reference time includes an execution start time of the first representative operation in each stage and the execution start time of the previous evaluation operation. The control unit 22 includes a timer, resets the value of the timer at the reference time, and determines that a certain period of time has elapsed from the reference time when the value of the timer becomes equal to or greater than a threshold. In addition, the evaluation execution condition includes that the number of executions of the representative operation in each stage reaches a certain number of times. The control unit 22 includes a counter, resets the value of the counter before the start of execution of the first representative operation in each stage, and increments the value of the counter each time the representative operation is executed. The control unit 22 determines that the number of executions of the representative operation in each stage reaches a certain number of times when the value of the counter is equal to or greater than the threshold.

In a case where the evaluation execution condition is not satisfied (step SP05: NO), the processing in and after step SP03 is executed.

In a case where the evaluation execution condition is satisfied (step SP05: YES), next, in step SP06, the information processing unit 11 executes evaluation result output processing. The processing of step SP06 corresponds to evaluation result output processing executed within a period in which the representative operation of each stage is executed.

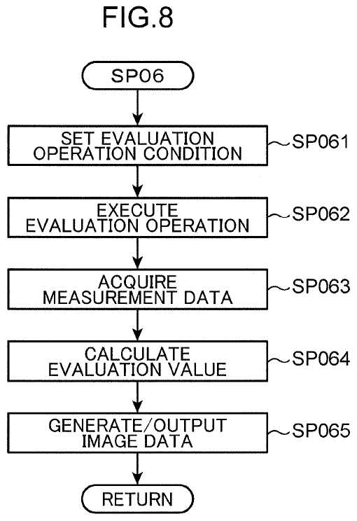

FIG. 8 is a flowchart illustrating details of the evaluation result output processing.

First, in step SP061, the control unit 22 sets an evaluation operation condition for executing the evaluation operation.

The evaluation operation condition includes operation designation information for designating an operation to be executed in the evaluation operation among all the N operations. The evaluation operation may be all the operations. An accurate comprehensive evaluation can be made by causing the production device 2 to perform all the operations as the evaluation operation. Furthermore, the evaluation operation may be a differential operation between all the operations and the most recent representative operation with respect to the evaluation operation. As the evaluation operation, by causing the production device 2 to perform the differential operation between all the operations and the most recent representative operation with respect to the evaluation operation, the efficiency of the evaluation operation can be improved while the accuracy of the comprehensive evaluation is being maintained. Furthermore, the evaluation operation may be a prescribed operation prescribed from all the operations. As the evaluation operation, the efficiency of the evaluation operation can be improved by causing the production device 2 to operate a prescribed operation prescribed from all the operations.

The evaluation operation condition includes setting information of the value of the control parameter 31 when the evaluation operation is executed. As the control parameter 31 at the time of executing the evaluation operation, the latest control parameter 31 stored in the storage unit 41 at the present time may be used as it is. Alternatively, the control parameter 31 when the evaluation operation is executed next time may be set based on a plurality of evaluation values related to a plurality of representative operations executed during a period from the time of execution of the previous evaluation operation to the present time. For example, the control unit 22 specifies the best evaluation value from a plurality of evaluation values related to a plurality of representative operations executed during a period from the time point of execution of the previous evaluation operation to the current time point, and sets the control parameter 31 set when the representative operation corresponding to the best evaluation value is executed as the control parameter 31 when the evaluation operation is executed next time. This makes it possible to improve the evaluation accuracy of the comprehensive evaluation by executing the evaluation operation.

Next, in step SP062, the control unit 22 generates a control signal for causing the production device 2 to execute the evaluation operation set in step SP061. The control signal generated by the control unit 22 is transmitted to the production device 2 by the communication unit 15. When the production device 2 receives the control signal, the control unit 42 executes the evaluation operation by controlling the drive unit 43 based on the control signal and the control parameter 31 read from the storage unit 41. When the production device 2 executes the evaluation operation, the sensor 3 transmits the measurement data 33 corresponding to each operation included in the evaluation operation to the control parameter generation device 1. The communication unit 15 receives the measurement data 33 transmitted from the sensor 3, stores the X pieces of measurement data in the storage unit 12, and inputs the X pieces of measurement data to the information processing unit 11.

Next, in step SP063, the acquisition unit 23 acquires the measurement data 33 corresponding to each operation included in the evaluation operation from the communication unit 15.

Next, in step SP064, the output unit 25 calculates an evaluation value of the evaluation index for each piece of the measurement data 33 acquired by the acquisition unit 23. In the example of the present embodiment, the output unit 25 calculates the settling time for each measurement data 33, and sets the longest settling time among the plurality of settling times regarding the plurality of measurement data 33 as the evaluation value related to the current evaluation operation.

Next, in step SP065, the output unit 25 generates image data including the evaluation result regarding the current evaluation operation, and outputs the generated image data. The image data output from the output unit 25 is input to the display unit 14, and the display unit 14 displays an image based on the input image data.

Referring to FIG. 6, in step SP07 next to step SP06, the control unit 22 determines whether a predetermined optimization end condition is satisfied. As the optimization end condition, a target value of the evaluation value related to the evaluation operation may be set, an upper limit number of summing times of total values of the number of repetitions of the optimization processing in all the stages up to the current time may be set, or an upper limit time of the execution time of the optimization processing in all the stages up to the current time may be set. For example, in a case where the target value of the evaluation value is set as the optimization end condition, the control unit 22 determines that the optimization end condition is not satisfied in a case where the evaluation value (longest settling time) of the most recent evaluation operation exceeds a target value, but determines that the optimization end condition is satisfied when the evaluation value of the most recent evaluation operation is equal to or less than the target value.

In a case where the optimization end condition is not satisfied (step SP07: NO), the processing of step SP03 and subsequent steps is executed.

In a case where the optimization end condition is satisfied (step SP07: YES), the optimization processing of the control parameter 31 ends. In a case where the evaluation result of the comprehensive evaluation by performing the evaluation operation satisfies the optimization end condition, the optimization processing ends even before the representative operations arrive at the final stage, and thus the time required for the optimization processing can be shortened.

In a case where the representative operation end condition is satisfied in the determination of step SP04 (step SP04: YES), next, in step SP08, the selection unit 21 determines whether the number X of operations included in the representative operations is equal to the number N of operations of all the operations.

In a case where X is equal to N (step SP08: YES), since the representative operation has reached the final stage (the eighth stage in the example of FIG. 3), the optimization processing of the control parameter 31 ends.

In a case where X is less than N (step SP08: NO), since the representative operation has not reached the final stage, the selection unit 21 updates X by referring to the selection rule 32 in step SP09. That is, the selection unit 21 shifts the selection of the X representative operations from the current stage to the next stage from all the N operations.

Next, in step SP10, the control unit 22 determines whether a predetermined evaluation execution condition is satisfied. The evaluation execution condition includes that a certain time has elapsed from the reference time. The reference time includes the execution start time of the previous evaluation operation. The control unit 22 includes a timer, resets the value of the timer at the reference time, and determines that a certain period of time has elapsed from the reference time when the value of the timer becomes equal to or greater than a threshold.

In a case where the evaluation execution condition is not satisfied (step SP10: NO), the processing in and after step SP03 is executed.

In a case where the evaluation execution condition is satisfied (step SP10: YES), next, in step SP11, the information processing unit 11 executes evaluation result output processing. The processing of step SP11 corresponds to evaluation result output processing executed within a transition period from a certain stage to the next stage. Details of the evaluation result output processing in step SP11 are illustrated by the flowchart illustrated in FIG. 8. The determination processing in step SP10 may be omitted, and step SP11 may be always executed in a case where X is updated.

Next, in step SP12, the control unit 22 determines whether a predetermined optimization end condition is satisfied. Details of the optimization end condition in step SP12 are similar to the details of the optimization end condition in step SP07.

In a case where the optimization end condition is not satisfied (step SP12: NO), the processing of step SP03 and subsequent steps is executed.

In a case where the optimization end condition is satisfied (step SP12: YES), the optimization processing of the control parameter 31 ends. In a case where the evaluation result of the comprehensive evaluation by performing the evaluation operation satisfies the optimization end condition, the optimization processing ends even before the representative operations arrive at the final stage, and thus the time required for the optimization processing can be shortened.

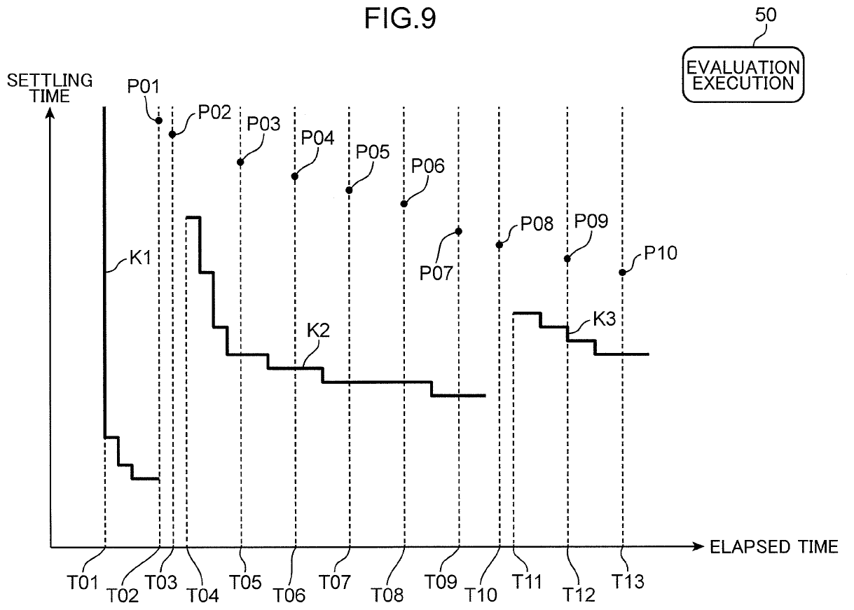

FIG. 9 is a diagram illustrating an example of an image including evaluation results regarding a representative operation and an evaluation operation in a simplified manner. The image includes time-series data of an evaluation value Q related to the representative operation and time-series data of an evaluation value P related to the evaluation operation. In the example illustrated in FIG. 9, the evaluation value is the settling time on the vertical axis, and the elapsed time on the horizontal axis. A characteristic K1 is a line graph connecting the best values among the plurality of evaluation values Q regarding the plurality of representative operations repeated in the first stage, a characteristic K2 is a line graph connecting the best values among the plurality of evaluation values Q regarding the plurality of representative operations repeated in the second stage, and a characteristic K3 is a line graph connecting the best values among the plurality of evaluation values Q regarding the plurality of representative operations repeated in the third stage.

An evaluation value P01 is an evaluation value related to the evaluation operation executed at time T02 after a lapse of a certain time from an execution start time TO1 of the first representative operation in the first stage. An evaluation value P02 is an evaluation value related to the evaluation operation executed at time T03 in the transition period from the first stage to the second stage. An evaluation value P03 is an evaluation value related to the evaluation operation executed at time T05 after a lapse of a certain time from an execution start time T04 of the first representative operation in the second stage. Evaluation values P04 to P07 are evaluation values regarding the evaluation operation executed at times T06 to T09 after a lapse of a certain time from times T05 to T08, respectively. An evaluation value P08 is an evaluation value related to the evaluation operation executed at time T10 in the transition period from the second stage to the third stage. An evaluation value P09 is an evaluation value related to the evaluation operation executed at time T12 after a lapse of a certain time from an execution start time T11 of the first representative operation in the third stage. An evaluation value P10 is an evaluation value related to the evaluation operation executed at time T12 after a lapse of a certain time from time T13.

In addition, the image includes an icon 50 written as evaluation execution. When the user clicks the icon 50 or the like by an operation input using the input unit 13, an execution request of the evaluation operation is input to the information processing unit 11. When receiving the execution request, the information processing unit 11 executes evaluation result output processing similar to steps SP06 and SP11.

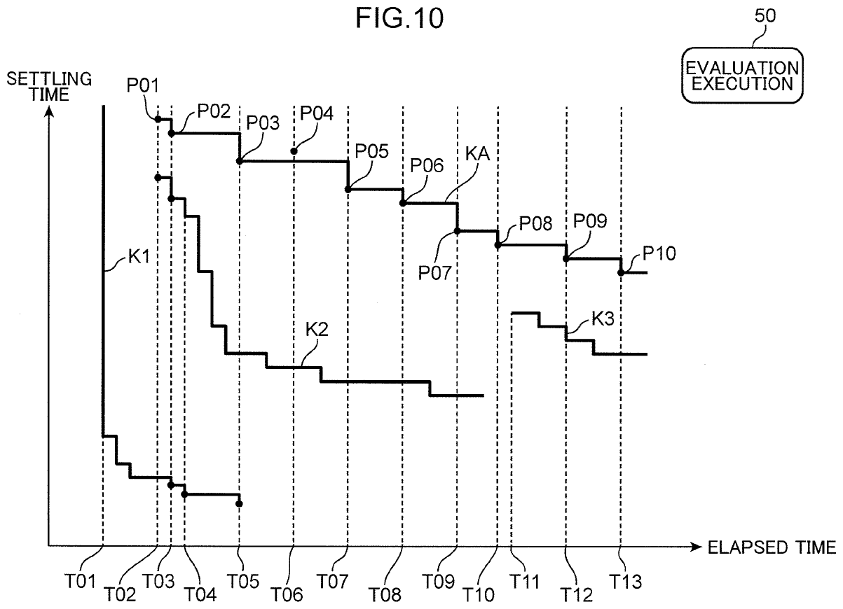

FIG. 10 is a diagram illustrating a modification of the image including the evaluation results regarding the representative operation and the evaluation operation in a simplified manner. A characteristic KA is a line graph connecting the best values among the plurality of evaluation values P regarding the evaluation operation. In the example of FIG. 10, since the evaluation value P04 is worse than the evaluation value P03, the evaluation value P04 is excluded from the characteristic KA. In a case where the representative operation corresponding to the characteristic K1 is included in the evaluation operation executed after time T02, the characteristic K1 may be extended and displayed also after time T02 by extracting the evaluation value Q corresponding to the characteristic K1 from the evaluation values P after time T02. The same applies to the other characteristics K. Furthermore, in a case where the representative operation corresponding to the characteristic K2 is included in the evaluation operation executed before time T04, the characteristic K2 may be displayed retroactively also before time T04 by extracting the evaluation value Q corresponding to the characteristic K2 from the evaluation values P before time T04. The same applies to the other characteristics K.

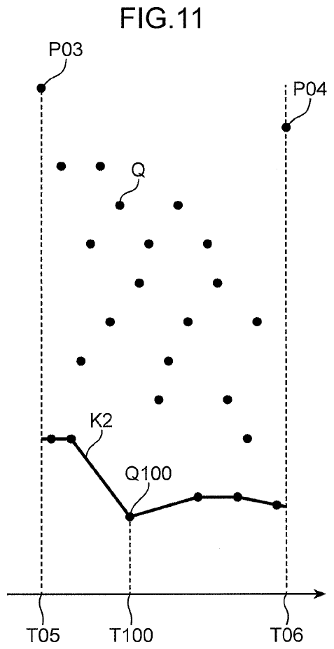

FIG. 11 is an enlarged view of a part of the image illustrated in FIG. 9. In addition to the notation of the broken line graph of the characteristic K, a plot of a plurality of evaluation values Q regarding a plurality of representative operations repeated in each stage may be written. Alternatively, only the plots of the plurality of evaluation values Q may be illustrated, and the broken line graph of the characteristic K may be omitted.

The user can select one evaluation value from the time-series data of the evaluation value Q related to the representative operation by the operation input using the input unit 13. For example, when the user clicks an evaluation value Q100 on the characteristic K2 (or time T100 on the horizontal axis) or the like, the selection information of the evaluation value Q100 is input to the information processing unit 11. When receiving the selection information, the information processing unit 11 reads, from the storage unit 12, the control parameter 31 when the representative operation corresponding to the evaluation value Q100 is executed, and sets the control parameter 31 when the evaluation operation is executed next time based on the control parameter 31. For example, the control parameter 31 when the evaluation operation is executed next time is set equal to the control parameter 31 when the representative operation corresponding to the evaluation value Q100 is executed. Since the user can easily set the control parameter 31 when the evaluation operation is executed next time by the input operation while viewing the screen displayed on the display unit 14, the convenience of the user can be improved.

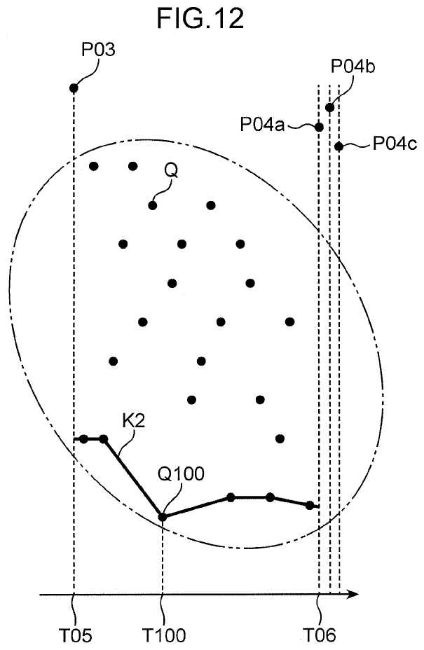

FIG. 12 is an enlarged view illustrating a part of another example of the image including the evaluation result. In the above example, the evaluation operation is executed once at each execution timing, but the number of executions of the evaluation operation is not limited to one and may be a plurality of times. The control unit 22 calculates the variance of the plurality of evaluation values Q (the plurality of evaluation values Q included in the region indicated by the two-dot chain line in FIG. 11) regarding the plurality of representative operations executed from the previous execution time T05 of the evaluation operation to the current time T06. The control unit 22 sets the number of executions of the evaluation operation to be executed next time based on the calculated variance. For example, the control unit 22 sets the number of executions to be larger as the variance is larger, and sets the number of executions to be smaller as the variance is smaller. In the example illustrated in FIG. 11, three evaluation operations are executed at time T06, and evaluation values P04a, P04b, and P04c regarding the respective evaluation operations are indicated. As a result, since the number of executions of the evaluation operation to be executed next time can be appropriately set, the evaluation accuracy of the comprehensive evaluation can be improved.

As described above, according to the present embodiment, the control parameter 31 is updated by causing the production device 2 to execute the representative operation among all the N operations, and the number of operations included in the representative operation is gradually increased to repeat the optimization processing. As a result, it is possible to efficiently generate the appropriate control parameter 31.

Furthermore, according to the present embodiment, for example, in at least one of the first period (times T01 to T02) in which the representative operation of the first stage (first representative operation) is executed, the second period (times T04 to T09) in which the representative operation of the second stage (second representative operation) is executed, and the third period (times T02 to T04) between the first period and the second period, the production device 2 is caused to execute the predetermined evaluation operation to perform the comprehensive evaluation, and the output unit 25 outputs the result data indicating the evaluation result. Therefore, it is possible to present the progress of the optimization of the control parameter 31 in all the operations of the production device 2 to the user in the middle stage of the optimization processing.

### INDUSTRIAL APPLICABILITY

The present disclosure is widely applicable to a system or the like that generates control parameters.

1. An information processing method for optimizing control parameters in a device that executes a plurality of operations based on a plurality of the control parameters, the information processing method performed by an information processing device, comprising:
in control parameter optimization processing, selecting at least one representative operation from all operations that can be executed by the device, executing the selected representative operation by the device, acquiring measurement data of a predetermined evaluation index measured in the executing of the representative operation, and updating the control parameter based on the acquired measurement data,
the representative operation including a first representative operation and a second representative operation executed after the first representative operation; and
in evaluation result output processing, executing, by the device, a predetermined evaluation operation for comprehensively evaluating an operation of the device in at least one of a first period in which the first representative operation is executed, a second period in which the second representative operation is executed, and a third period between the first period and the second period, acquiring measurement data of the evaluation index measured in execution of the evaluation operation, performing the comprehensive evaluation based on the acquired measurement data, and outputting result data indicating an evaluation result of the comprehensive evaluation.

2. The information processing method according to claim 1, wherein the evaluation operation is all the operations.

3. The information processing method according to claim 2, wherein in the control parameter optimization processing, a next representative operation is selected based on execution results of all the operations executed as the evaluation operation.

4. The information processing method according to claim 3, wherein in the control parameter optimization processing, all the operations executed as the evaluation operation is clustered into a plurality of clusters, and the next representative operation is selected from each cluster.

5. The information processing method according to claim 1, wherein the evaluation operation is a differential operation between all the operations and a most recent representative operation with respect to the evaluation operation.

6. The information processing method according to claim 1, wherein the evaluation operation is a prescribed operation defined in advance from all the operations.

7. The information processing method according to claim 1, wherein in the outputting of the result data, an image indicating the evaluation result is generated as the result data, and the generated image is displayed on a display unit.

8. The information processing method according to claim 7, further comprising:
calculating an evaluation value of the evaluation index related to the representative operation based on the measurement data acquired along with execution of the representative operation; and
calculating an evaluation value of the evaluation index related to the evaluation operation based on the measurement data acquired along with execution of the evaluation operation, wherein
the image includes:
time-series data of the evaluation value related to the representative operation; and
time-series data of the evaluation value related to the evaluation operation.

9. The information processing method according to claim 8, further comprising: extracting an evaluation value corresponding to the representative operation from evaluation values of the evaluation indexes related to the evaluation operation to add the time-series data of the evaluation value related to the representative operation.

10. The information processing method according to claim 8, further comprising:
receiving, by a user, an input operation of a request for selecting one evaluation value from the time-series data of the evaluation value related to the representative operation; and
setting the control parameter when the evaluation operation is executed next time, based on the control parameter when the representative operation corresponding to the one evaluation value is executed.

11. The information processing method according to claim 1, further comprising: determining whether the evaluation result of the comprehensive evaluation satisfies a predetermined end condition; and ending the optimization processing of the control parameter in a case where the evaluation result satisfies the end condition.

12. The information processing method according to claim 1, further comprising:
receiving an input operation of a request for executing of the evaluation operation by a user; and
executing, by the device, the evaluation operation based on the execution request.

13. The information processing method according to claim 1, further comprising:
calculating an evaluation value of the evaluation index related to the representative operation based on the measurement data acquired along with execution of the representative operation;
calculating a variance of a plurality of the evaluation values related to a plurality of the representative operations; and
setting a number of executions of the evaluation operation to be executed next time based on the variance.

14. The information processing method according to claim 1, further comprising:
calculating an evaluation value of the evaluation index related to the representative operation based on the measurement data acquired along with execution of the representative operation; and
setting the control parameter when the evaluation operation is executed next time, based on a plurality of the evaluation values related to a plurality of the representative operations.

15. The information processing method according to claim 14, wherein
in the setting of the control parameter, the control parameter when the representative operation corresponding to a best evaluation value among a plurality of the evaluation values is executed is set as the control parameter when the evaluation operation is executed next time.

16. An information processing method for optimizing control parameters in a device that executes a plurality of operations based on a plurality of the control parameters, the information processing method performed by an information processing device, comprising:
selecting at least one representative operation from all operations that can be executed by the device, executing the selected representative operation by the device, acquiring measurement data of a predetermined evaluation index measured in the executing of the representative operation, and updating the control parameter based on the acquired measurement data;
executing, by the device, a predetermined evaluation operation for comprehensively evaluating an operation of the device within a period in which the representative operation is executed, acquiring measurement data of the evaluation index measured in execution of the evaluation operation, and performing the comprehensive evaluation based on the acquired measurement data; and
selecting a next representative operation based on an execution result of the evaluation operation.

17. An information processing device for optimizing control parameters in a device that executes a plurality of operations based on a plurality of the control parameters, the information processing device comprising a processor, the processor performs a process comprising
in control parameter optimization processing, selecting at least one representative operation from all operations that can be executed by the device, executing the selected representative operation by the device, acquiring measurement data of a predetermined evaluation index measured in the executing of the representative operation, and updating the control parameter based on the measurement data,
the representative operation includes a first representative operation and a second representative operation executed after the first representative operation, and
in evaluation result output processing, executing, by the device, a predetermined evaluation operation for comprehensively evaluating an operation of the device in at least one of a first period in which the first representative operation is executed, a second period in which the second representative operation is executed, and a third period between the first period and the second period, acquiring measurement data of the evaluation index measured in execution of the evaluation operation, performing the comprehensive evaluation based on the acquired measurement data, and outputting result data indicating an evaluation result of the comprehensive evaluation.

18. A computer-readable non-transitory recording medium recording a program for causing an information processing device for optimizing control parameters in a device that executes a plurality of operations based on a plurality of the control parameters to execute selection processing, control processing, acquisition processing, update processing, and output processing, wherein
in control parameter optimization processing, the selection processing selects at least one representative operation from all operations that can be executed by the device, the control processing causes the device to execute the representative operation selected by the selection processing, the acquisition processing acquires measurement data of a predetermined evaluation index measured in the executing of the representative operation, and the update processing updates the control parameter based on the measurement data acquired by the acquisition processing,
the representative operation includes a first representative operation and a second representative operation executed after the first representative operation, and
in evaluation result output processing, the control processing causes the device to execute a predetermined evaluation operation for comprehensively evaluating an operation of the device in at least one of a first period in which the first representative operation is executed, a second period in which the second representative operation is executed, and a third period between the first period and the second period, the acquisition processing acquires measurement data of the evaluation index measured in execution of the evaluation operation, and the output processing performs the comprehensive evaluation based on the measurement data acquired by the acquisition processing and outputs result data indicating an evaluation result of the comprehensive evaluation.
